(19) United States
(12) Patent Application Publication
(10) Pub. No.: US 2013/0345358 A1
(43) Pub. Date: Dec. 26, 2013

(54) USE OF BRANCHED ADDITION COPOLYMERS IN CURING SYSTEMS

(71) Applicants: Paul Hugh Findlay, Liverpool (GB); Sharon Todd, Liverpool (GB); Steven Paul Rannard, Liverpool (GB); Brodyck James Lachlan Royles, Liverpool (GB); Neil John Simpson, Liverpool (GB); Roselyne Marie Andree Baudry, Liverpool (GB)

(72) Inventors: Paul Hugh Findlay, Liverpool (GB); Sharon Todd, Liverpool (GB); Steven Paul Rannard, Liverpool (GB); Brodyck James Lachlan Royles, Liverpool (GB); Neil John Simpson, Liverpool (GB); Roselyne Marie Andree Baudry, Liverpool (GB)

(73) Assignee: UNILEVER PLC, London (GB)

(21) Appl. No.: 13/496,844

(22) PCT Filed: Sep. 16, 2010
(86) PCT No.: PCT/GB2010/001741

§ 371 Date: Jul. 26, 2013

(30) Foreign Application Priority Data
Sep. 17, 2009 (GB) 0916338.7

(51) Int. Cl. C08F 220/14; C09D 133/12

(52) U.S. Cl. CPC C08F 220/14; C09D 133/12
USPC 524/558; 526/320

(57) ABSTRACT

The present invention relates to the use of branched addition copolymers in systems which can be cured post synthesis to form for example polymer coatings, sealants, inks, adhesives or composites and also relates to methods of preparing the cured systems, compositions comprising such copolymers and the use of the compositions in for example but not limited to coatings, inks, sealants, adhesives or composites.

### CROSS-REFERENCE TO RELATED APPLICATIONS

This application is the national phase entry of PCT Application No. PCT/GB2010/001741, filed Sep. 16, 2010, which claims priority to GB Application No. 0916338.7, filed Sep. 17, 2009. The disclosures of said applications are hereby incorporated herein by reference.

### TECHNICAL FIELD

The present invention relates to branched addition copolymers, more specifically, the present invention relates to the use of branched addition copolymers in systems which can be cured post synthesis to form for example polymer coatings, sealants, adhesives or composites. The application also relates to methods of preparing the cured systems, compositions comprising such copolymers and the use of the compositions in for example but not limited to coatings, sealants, inks, adhesives or composites.

### BACKGROUND

The present invention relates to branched addition copolymers which can be cured via a cross-linking reaction and their use in for example coatings, inks, sealants, adhesives and composites.

It is possible to prepare polymers with inherent functionalities that can be post modified via a chemical reaction. The chemical reaction may take place between functionalities on a single polymer or between two or more polymers. In addition, the chemical reaction may take place either with or without a catalyst or initiator, or involve a specific small molecule all with the aim of producing a three-dimensional cross-linked matrix. This post modifying chemical reaction is often referred to as a curing reaction and may create inter or intra molecular covalent or ionic bonding. The curing reaction typically takes place in-situ in the final form of the product and may lead to for example a monolithic moulding or the preparation of a coating.

Reactive moieties can be incorporated into a polymer either through the choice of a suitable reactive monomer or by post-functionalisation of the prepared polymer. The functionalities may then be reacted with themselves, for example through the incorporation of unsaturated groups, and cured with or without the use of a suitable catalyst or initiator. Alternatively, mutually reactive units can be included either in the same polymer structure or alternatively, a polymer with a first functionality can be reacted with a polymer or small molecule with a complimentary reactive unit.

Suitable curing reactions include the polymerisation of for example a pendant alkene unit such as a vinyl or allyl unit, or alternatively, the reaction may be between two reactive units to form a covalent bond, such as the formation of an ester or amide link, the ring opening of an epoxide, formation of a urethane or urea bond, nucleophilic substitution or addition, electrophilic substitution or addition or via the formation of an ionic linkage, for example through the formation of a salt bridge.

Curing reactions may take place at ambient temperature or through thermal means or via a photochemical reaction, typically via a UV source. Additional initiators may also be used, for example a free radical initiator where the reactive species is an alkene unit. Catalysts may also be used to accelerate the curing step such as for example a strong acid in the case of the preparation of an ester or amide linkage, or a transition metal compound in the case of urethane or urea formation.

Cured polymers have the advantage of being more environmentally resilient than uncured materials due to the cross-linked network. The curing mechanism does however render the material essentially intractable hence the requirement for pre-formation into the desired end product prior to the cross-linking step.

Cured polymer coatings, such as so-called two-pack formulations, are widely used in a number of applications. As mentioned previously, the formation of a three dimensional network during the curing step aids the resilience of the coating. Such formulations include alkyd, epoxy or polyurethane systems.

Polymer composites are typically comprised of an inert matrix or filler in conjunction with a curable polymer with or without a solvent. These materials are usually cured through the incorporation of an initiator, catalyst or a small molecular weight reactive adjunct. Composites are utilised to form moulded products or to form laminar structures such as in the case of glass or carbon fibre resin composites.

Superior adhesives and sealants may also be obtained from curable polymeric formulations. In such cases a curing reaction between the functional polymers and the substrate is advantageous.

In all of the cases listed above a number of reactive chemistries can be exploited, essentially any reaction that can form a covalent or ionic bond between two molecules can be utilised. Here follows a non-exclusive list of the functional groups and reactions that can be incorporated into a polymer and instigated to provide a cured polymer.

In all of the cases below, the functional group can be incorporated into the polymer structure via the use of functional monomers or alternatively the reactive moiety can be introduced through a further reactive step onto a pre-formed polymer. In most cases the reaction occurs by means of both inter and intra molecular reactions.

Alkene polymerisation. An unsaturated carbon-carbon unit in the form of for example an alkene bond, can be essentially polymerised, usually via a free radical procedure. In such a mechanism the polymerisation occurs via the introduction of a free radical initiator which is then dissociated thermally, by the use of UV radiation or via a chemical means such as a redox reaction, to generate free radicals which react with the unsaturated units and provide a cured polymer, or alternatively via a transition metal catalyst “dryer” in the case of alkyd systems. Allyl, vinyl or alkyd functional polymers are typically used in this type of curing.

In the following cases the mutually reactive carbon units described can be present within the same polymer structure or, the reactive moieties may arise through the reaction of two polymers, or, by the reaction of one polymer and one small molecule, wherein the complimentary functionalities on each polymer or molecule may react.

Ester or amide formation. Alcohol or amine and carboxylic acid functionalities can be reacted to provide an ester or an amide linker unit respectively. These linking reactions are typically thermally initiated in the presence of a strong acid catalyst. Another route to these types of linkages is the reaction of an alcohol or amine with an anhydride or azlactone, or through the transesterification or transamidation of an activated ester such as that found in the monomer methyl acrylamidoglycolate methyl ether.

Epoxide ring-opening. In this case a compound possessing an epoxide ring is reacted with a nucleophilic material, usually a primary or secondary amine. The amine epoxy reaction is catalysed by a hydroxylic species such as phenols and alcoholic solvents. Epoxides can also react with other nucleophilic species such as thiols or carboxylic acids, in the presence of a tri- alkyl or aryl phosphine catalyst. The epoxide can also be homopolymerised via the use of a Lewis or Bronsted acid such as boron tri-fluoride or tri-fluoromethane sulfonic acid.

Isocyanate chemistry. In this case, an isocyanate group is reacted with a group possessing an active hydrogen such as a hydroxyl group, a thiol or an amine The polymer usually possesses the active hydrogen nucleophile and is reacted with a smaller molecular weight di- or poly-isocyanate, such as 2,4-tolyene diisocyanate. Blocked isocyanates, where the isocyanate unit has been reacted with a labile monofunctional active hydrogen compound can also be used, in which case the isocyanate is rendered less reactive and the formulation can be stored as a stable one-pack formulation.

Thiol-ene chemistry. In thiol-ene chemistry, the radical reaction between a thiol functionality and an electron-rich olefin is utilised to form a thio-ether linkage. These reactions are typically initiated by photochemical means.

Disulfide curing. The reaction of two thiol units to form a disulfide can be undertaken through oxidation, for example by the use of hydrogen peroxide. This curing method is particularly prevalent in adhesives and sealants.

Silicone curing systems. The formation of siloxane linkages can be achieved through the reaction of an alkyloxysilane functionality where the curing proceeds via the elimination of a carboxylic acid, for example acetic acid in the case of an acetoxysilyl unit. These curing reactions are widely used in sealant technology.

Linear polymers are commonly used in many applications due to their high solubility and ease of preparation. Due to their architectures these polymers can give rise to high viscosity solutions or melts, in addition they can be extremely slow or difficult to dissolve or melt to give isotropic liquids. The high viscosity of these solutions can be problematic in a coating, sealant, adhesive or composite formulation where a large amount of solvent is required in order to provide a workable formulation. Where the solvent is organic in nature this can lead to a large amount of volatile organic compound (VOC) being necessary to use the linear polymer effectively. Increasing legislation to decrease the VOC levels of many formulations makes this undesirable. Linear addition polymers typically also have the functional group pendant to the main chain of the polymer, this can give rise to slow curing reactions due to the inaccessibility of functional groups within the interior of the polymer structure during the curing reaction. This in turn leads to longer cure times and higher cure temperatures in thermally mediated reactions.

The curing rate of a linear polymer system is typically proportional to the molecular weight of the macromolecule concerned. Ideally high molecular weight materials are preferred. However due the sharp increase in solution or melt viscosity of the formulation with increasing molecular weight a compromise in molecular weight must be achieved to avoid high amounts of solvent (typically a VOC) or temperature, in the case of melt processed systems, in the formulation. This can lead to process inefficiency due to the slow cure rates of these materials.

It has now been found that these disadvantages, namely the high viscosity of polymer systems, low cure rate or incomplete cross-linking can however be addressed by using a branched architecture.

### Branched Polymers

Branched polymers are polymer molecules of a finite size which are branched. Branched polymers differ from cross-linked polymer networks which tend towards an infinite size having interconnected molecules and which are generally not soluble. In some instances, branched polymers have advantageous properties when compared to analogous linear polymers. For instance, solutions of branched polymers are normally less viscous than solutions of analogous linear polymers. Moreover, higher molecular weights of branched copolymers can be solubilised more easily than those of corresponding linear polymers. In addition, as branched polymers tend to have more end groups than a linear polymer they generally exhibit strong surface-modification properties. It has now been found that the above properties render branched polymers useful components for a range of compositions and makes them an ideal choice for use in a variety of applications.

Branched or hyperbranched polymers can also be used in curable systems. Unlike dendrimers, branched or hyperbranched polymers typically show non-ideal branching in their structure and can possess polydisperse structures and molecular weights. Their preparation however can be much easier than their dendrimer counterparts and although their ultimate structure is not perfect or monodisperse, they are more suitable for a number of industrial applications.

Branched polymers are usually prepared via a step-growth mechanism via the polycondensation of suitable monomers and are usually limited by the choice of monomers, the chemical functionality of the resulting polymer and the molecular weight. In addition polymerisation, a one-step process can be employed in which a multifunctional monomer is used to provide functionality in the polymer chain from which polymer branches may grow. However, a limitation on the use of a conventional one-step process is that the amount of multifunctional monomer must be carefully controlled, usually to substantially less than 0 5% w/w in order to avoid extensive cross-linking of the polymer and the formation of insoluble gels. It is difficult to avoid cross-linking using this method, especially in the absence of a solvent as a diluent and/or at high conversion of monomer to polymer.

WO 99/46301 discloses a method of preparing a branched polymer comprising the steps of mixing together a monofunctional vinylic monomer with from 0.3 to 100% w/w (of the weight of the monofunctional monomer) of a multifunctional vinylic monomer and from 0.0001 to 50% w/w (of the weight of the monofunctional monomer) of a chain transfer agent and optionally a free-radical polymerisation initiator and thereafter reacting said mixture to form a copolymer. The examples of WO 99/46301 describe the preparation of primarily hydrophobic polymers and, in particular, polymers wherein methyl methacrylate constitutes the monofunctional monomer. These polymers are useful as components in reducing the melt viscosity of linear poly(methyl methacrylate) in the production of moulding resins.

WO 99/46310 discloses a method of preparing a (meth)acrylate functionalised polymer comprising the steps of mixing together a monofunctional vinylic monomer with from 0.3 to 100% w/w (based on monofunctional monomer) of a polyfunctional vinylic monomer and from 0.0001 to 50% w/w of a chain transfer agent, reacting said mixture to form a polymer and terminating the polymerisation reaction before 99% conversion. The resulting polymers are useful as components of surface coatings and inks, as moulding resins or in curable compounds, for example curable moulding resins or photoresists.

WO 02/34793 discloses a rheology modifying copolymer composition containing a branched copolymer of an unsaturated carboxylic acid, a hydrophobic monomer, a hydrophobic chain transfer agent, a cross-linking agent, and, optionally, a steric stabilizer. The copolymer provides increased viscosity in aqueous electrolyte-containing environments at elevated pH. The method for production is a solution polymerisation process. The polymer is lightly cross-linked, less than 0.25%.

U.S. Pat. No. 6,020,291 discloses aqueous metal working fluids used as lubricant in metal cutting operations. The fluids contain a mist-suppressing branched copolymer, including hydrophobic and hydrophilic monomers, and optionally a monomer comprising two or more ethylenically unsaturated bonds. Optionally, the metal working fluid may be an oil-in-water emulsion. The polymers are based on polyacrylamides) containing sulfonate-containing and hydrophobically modified monomers. The polymers are cross-linked to a very small extent by using very low amount of bis-acrylamide, without using a chain transfer agent.

EP 1505102 Al describes the formation of a hydrophilic coating for low friction coefficient medical devices comprising a functionalised dendritic molecule and a linear polymer based on polyvinyl pyrrolidinone cured via a UV process. The use of a functional dendritic polymer was seen to reduce the curing time of the coating when compared to an equivalent linear system.

EP 1616899 Al discloses the use of a photocurable polymer with a dendritic core in UV curable ink-jet applications. The dendritic polymers were synthesised to contain polymerisable, initiating and co-initiating groups capable of polymerising under UV curing conditions. The polymer was covalently cross-linked into the final ink formulation and had the advantages of being formed in a low viscosity formulation with reduced leaching from the final ink after curing.

WO 02/22700 describes the synthesis and use of a branched photocurable polymer containing at least one acrylic group and one tertiary amine group per molecule. The polymerisation was performed under UV radiation and via a Norrish II reaction. The incorporation of the polyfunctional curable branched polymer in a UV curing formulation was shown to increase the cure rate while exhibiting a low solution viscosity.

Méchin and co-workers (Reactive and Functional polymers, 66 (2006) 1462) describe the functionalisation of a fourth generation hyperbranched polyester with an aromatic diisocyanate. The polyol was prefunctionalised with this compound to overcome the miscibility problems of these type of branched polyols and a suitable curing diisocyanate. The polymer was prepared for use in a polyurethane film where the branched nature of the polymer would be expected to provide low viscosity and fast cure benefits.

Hult and co-workers (Progress in organic coatings 44 (2002) 63-67) report the functionalisation of a star-branched polyester through growing further ester oligomers from the hydroxyl functional groups via a reaction with c-caprolactone and functionalising the resulting terminal hydroxyl units with a methacrylate group. The rheology of the UV-initiated curing of this material was followed and the time to gellation increased linearly with increasing molecular weight for the branched polymer systems.

Fernandez-Francos et. al. (Journal of applied polymer science 111 (2008) 2822) describe the curing of a polyhydroxyl-functional dendritic polymer (Boltorn H30) with an epoxy-functional diglydidyl ether of bisphenol-A. The inclusion of the branched polymer resulted in reduced shrinkage during the curing of a monolith of this formulation with a faster onset of gellation.

### DETAILED DESCRIPTION

Polymers capable of undergoing a subsequent curing or cross-linking reaction are used in many everyday applications. Typically these polymers are of a linear architecture where the functional groups are either pendant to the polymer main chain or at the termini of the macromolecule. The polymers can be natural, synthetic or hybrid in composition and can either react via an intra or intermolecular mechanism. In the case of addition polymers the functionality is usually either pre-formed within the polymer structure through a choice of suitable reactive monomers or incorporated through a further chemical reaction. In these cases the functionality is usually placed along the main carbon chain backbone of the material. The concentration and location of the functionality can be tuned through the ratios of functional monomers utilised or by using a controlled technique respectively.

Problems associated with curing linear molecules. It has been now been found that the use of curable dendritic or branched polymers have a number of advantages over linear systems. The branched nature of dendritic or branched polymers means that these polymers give rise to solutions or melts of lower viscosity enabling higher solids compositions to be formulated. This then enables less solvent to be used which can be problematic where VOCs are employed. In many curable systems there is a growing trend toward high solids formulations, the presence of organic solvents is something of a liability as they impart flammability, high cost and in many cases toxicity and are almost entirely lost in the final cured system. Since the solvent usually plays no part in the curing mechanism, and in many cases hinders it, the removal of the solvent is preferential. The ability to formulate at high solids level is particularly attractive since it can lead to compositions with a higher concentration of active curable polymer thus leading to faster cure rates. In many applications cure rate is crucial in the coating or moulding of the final product and where this is thermally initiated, a number of cost savings can be made. In addition, due to the polyvalency in branched polymer systems there is also a greater availability of functional groups within the polymer structure and once more this can lead to faster cure times and in coatings formulations longer ‘pot-life’, in for example a ‘two-pack, formulation’. Another advantage is the faster onset of curing leading to faster gellation in the system which can lead to quicker tack-free time in coatings, adhesives and sealants.

Due to this high accessibility of functional groups and fast onset of gellation during curing there is typically greater formulation-substrate interaction leading to greater substrate adhesion, particularly desirable for adhesives, sealants or coatings.

Dendritic polymers are prepared via a multi-step synthetic route and are limited by chemical functionality and ultimate molecular weight. Being prepared at a high end cost; such molecules have therefore only limited high-end industrial applications. Branched polymers are typically prepared via a step-growth procedure and again are limited by their chemical functionality and molecular weight. However, the reduced cost of manufacturing such polymers makes them more industrially attractive. Due to the chemical nature of both of these classes of macromolecules (that is, such molecules typically possess ester or amide linkages), problems arising from their miscibility with olefin-derived polymers have been observed. This can be circumvented by the use of hydrocarbon-based, star-shaped polymers prepared via anionic polymerisation or the post-functionalisation of pre-formed dendrimers or branched species although this again leads to an increased cost in the materials.

Through previous disclosures the inventors have shown that branched polymers of high molecular weight can be prepared via a one-step process using commodity monomers. Through specific monomer choices the chemical functionality of these polymers can be tuned depending on the specific application. These benefits therefore give advantages over dendritic or step-growth branched polymers. Since these polymers are prepared via an addition process from commodity monomers, they can be tuned to give good miscibility with equivalent linear addition polymers. Since branched polymers comprise a carbon-carbon backbone they are not susceptible to thermal or hydrolytic instability unlike ester-based dendrimers or step-growth branched polymers. It has been observed that these polymers also dissolve faster than equivalent linear polymers.

In addition, since branched addition copolymers give rise to formulations with lower solution or melt viscosities, such polymers may be applied more readily than traditional systems where the working of more viscous polymers is generally employed. This is particularly true in cases where the formulation is spray applied, once more leading to significant cost savings by using branched addition copolymers.

In summary, the advantages of using branched curable polymers over linear systems are considerable, for example, higher solids content formulations can be achieved, low viscosity formulations can be prepared, less volatile organic compounds (VOCs) are required in the final formulation, faster cure rates can be achieved and greater substrate adhesion can be obtained.

The branched addition curable copolymers of the present invention are branched, non-cross-linked addition polymers and include statistical, block, graft, gradient and alternating branched copolymers. The copolymers of the present invention comprise at least two chains which are covalently linked by a bridge other than at their ends, that is, a sample of said copolymer comprises on average at least two chains which are covalently linked by a bridge other than at their ends. When a sample of the copolymer is made there may be accidentally some polymer molecules that are un-branched, which is inherent to the production method (addition polymerisation process). For the same reason, a small quantity of the polymer will not have a chain transfer agent (CTA) on the chain end.

### Applications.

The following is a non-exhaustive list of the advantages of applications for branched addition curable copolymers in accordance with the present invention:

Coatings - wherein a formulation of the branched addition curable copolymers can be prepared at high solids content or at reduced viscosity compared to linear polymeric systems. The cure rate can be reduced in addition to achieving faster tack-free time and a longer ‘pot-life’ with greater substrate adhesion.

Adhesives - wherein the use of the branched addition curable copolymers leads to adhesive formulations with lower viscosity and with a higher composition of curable adhesive actives. An improved adhesive strength can also be achieved.

Sealants - in which formulations with higher solids content can be prepared using less solvent and at a higher concentration of curable active leading to greater substrate adhesion.

Inks - wherein a faster curing polymer additive can lead to faster printing times and lower cure temperatures, as appropriate.

Composites - for which akin to sealants, formulations with a higher solids content can be prepared using less solvent and at a higher concentration of curable active, or filler, leading to composites with greater substrate adhesion and faster cure rate. In addition, due to the lower viscosity of the formulation, a greater matrix penetration can also be achieved.

Resins - through the incorporation of a branched curable copolymer, efficient solution or melt processing of resins can be achieved. In solution processing, the key advantages are the preparation of high solids formulations with low viscosities and low volatile organic compounds (VOCs). In melt processing, lower production temperatures can also be achieved.

Lithography—the use of a branched curable copolymer in a resist formulation for lithography means that the lower viscosity of the formulation aids the formation of more precise templates or structures. Once again, faster cure rates can be achieved

Therefore according to a first aspect of the present invention there is provided the use of a branched addition copolymer wherein the branched addition copolymer is cured to form a cross-linked formulation and wherein the branched addition copolymer is obtainable by an addition polymerisation process, and wherein the branched addition polymer comprises a weight average molecular weight of 2,000 Da to 1,500,000 Da.

The branched addition copolymer used according to the first aspect of the present invention comprises:

at least two chains which are covalently linked by a bridge other than at their ends; and wherein

the at least two chains comprise at least one ethyleneically monounsaturated monomer, and wherein

the bridge comprises at least one ethyleneically polyunsaturated monomer; and wherein

the polymer comprises a residue of a chain transfer agent and optionally a residue of an initiator; and wherein

the mole ratio of polyunsaturated monomer(s) to monounsaturated monomer(s) is in a range of from 1:100 to 1:4.

In addition, the branched addition polymer is cured after formation of the branched addition polymer in the addition polymerisation process.

The branched addition copolymer may be cured by the addition of a reactive polymer, oligomer or small molecular weight reactive molecule, or the branched addition copolymer may be cured by means of thermal, photolytic, oxidative, reductive or by the addition of a catalyst or initiator.

The branched addition copolymer used in accordance with the first aspect of the present invention is prepared from monomers comprising one or more of the following groups: hydroxyl, mercapto, amino, carboxylic, epoxy, isocyanate, pyridinyl, vinyl, allyl, (meth)acrylate, styrenyl.

The branched addition copolymer is cured by means of the reaction of mutually reactive functional groups provided on the monomers.

The branched addition copolymer used according to the first aspect of the present invention comprises less than 1% impurity. More specifically in the present invention the branched addition copolymers are polymerised to give less than 1% monomer impurity.

In addition, the branched addition polymer comprises a weight average molecular weight of 3,000 Da to 900,000 Da.

The use of the cured branched copolymer according to the first aspect of the present invention extends to the application areas selected from the group comprising: coatings, adhesives, inks, composites, sealants and cured resins.

Preferably, the branched addition copolymers used according to the first aspect of the present invention comprises units selected from the groups consisting of: styrene, vinyl benzyl chloride, 2-vinyl pyridine, 4-vinyl pyridine, methyl acrylate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, divinyl benzene, ethyleneglycol dimethacrylate, ethyleneglycol diacrylate, triethylene glycol dimethacrylate, tetraethyleneglycol dimethacrylate, triethyleneglycol diacrylate, tetraethyleneglycol diacrylate, glycidyl methacrylate, Tetrahydrofurfuryl methacrylate, (thiirane-2-yl)methyl methacrylate, 1,3,5-triallyl-1,3,5-triazine-2,4,6(1H,3H,5H)-trione, dodecane thiol, hexane thiol, 2-mercaptoethanol and fragments arising from azobis isobutyronitrile, di-t-butyl peroxide and t-butyl peroxybenzoate.

More preferably the branched addition copolymer comprises units selected from the groups consisting of: styrene, glycidyl methacrylate, 2-vinyl pyridine, 4-vinyl pyridine, methyl acrylate, methyl methacrylate, butyl methacrylate, butyl acrylate, acrylic acid, methacrylic acid, acrylamide, methacrylamide, dimethyl acrylamide, dimethyl(meth)acrylamide, styrenesulfonic acid, 2-acrylamido 2-methylpropane sulfonic acid, divinyl benzene, ethyleneglycol dimethacrylate, ethyleneglycol diacrylate, triethylene glycol dimethacrylate, dodecane thiol, hexane thiol, 2-mercaptoethanol, azobis isobutyronitrile, di-t-butyl peroxide and t-butyl peroxybenzoate.

Also provided in connection with a second aspect of the present invention is a cured coating, adhesive, ink or sealant composition prepared using a branched addition copolymer as described in accordance with a first aspect of the present invention wherein the cured composition further comprises a hardener selected from the group consisting of: dibromopentane, dibromo hexane, dibromoheptane, dibromooctane, diiodo pentane, diidohexane, diiodoheptane, diiodooctane, tetramethylhexane 1,6 diaminohexane, tertamethyethylene diamine, tetramethylbutane 1,4 diamine, tolylene diisocyanate and hexamethylene diisocyanate.

According to further aspects of the present invention there is provided a resin comprising a cured branched addition copolymer as described in relation to the first aspect of the present invention; a composite comprising a cured branched addition copolymer as described in relation to the first aspect of the present invention; a coating comprising a cured branched addition copolymer as described in relation to the first aspect of the present invention; an ink comprising a cured branched addition copolymer as described in relation to the first aspect of the present invention and an adhesive comprising a cured branched addition copolymer as described in relation to the first aspect of the present invention.

According to a third aspect of the present invention there is provided a curing composition containing a branched addition copolymer which shows faster cure rate; better adhesion; greater scratch resistance than for an equivalent formulation containing a linear polymer.

The chain transfer agent (CTA) is a molecule which is known to reduce molecular weight during a free-radical polymerisation via a chain transfer mechanism. These agents may be any thiol-containing molecule and can be either monofunctional or multifunctional. The agent may be hydrophilic, hydrophobic, amphiphilic, anionic, cationic, neutral, zwitterionic or responsive. The molecule can also be an oligomer or a pre-formed polymer containing a thiol moiety. (The agent may also be a hindered alcohol or similar free-radical stabiliser). Catalytic chain transfer agents such as those based on transition metal complexes such as cobalt bis(borondifluorodimethyl-glyoximate) (CoBF) may also be used. Suitable thiols include but are not limited to C₂ to C₁₈ branched or linear alkyl thiols such as dodecane thiol, functional thiol compounds such as thioglycolic acid, thio propionic acid, thioglycerol, cysteine and cysteamine Thiol-containing oligomers or polymers may also be used such as for example poly(cysteine) or an oligomer or polymer which has been post-functionalised to give a thiol group(s), such as poly(ethyleneglycol) (di)thio glycollate, or a pre-formed polymer functionalised with a thiol group. For example, the reaction of an end or side-functionalised alcohol such as poly(propylene glycol) with thiobutyrolactone, to give the corresponding thiol-functionalised chain-extended polymer. Multifunctional thiols may also be prepared by the reduction of a xanthate, dithioester or trithiocarbonate end-functionalised polymer prepared via a Reversible Addition Fragmentation Transfer (RAFT) or Macromolecular Design by the Interchange of Xanthates (MADIX) living radical method. Xanthates, dithioesters, and dithiocarbonates may also be used, such as cumyl phenyldithioacetate. Alternative chain transfer agents may be any species known to limit the molecular weight in a free-radical addition polymerisation including alkyl halides, ally-functional compounds and transition metal salts or complexes. More than one chain transfer agent may be used in combination.

Hydrophobic CTAs include but are not limited to linear and branched alkyl and aryl (di)thiols such as dodecanethiol, octadecyl mercaptan, 2-methyl-1-butanethiol and 1,9-nonanedithiol. Hydrophobic macro-CTAs (where the molecular weight of the CTA is at least 1000 Daltons) can be prepared from hydrophobic polymers synthesised by RAFT (or MADIX) followed by reduction of the chain end, or alternatively the terminal hydroxyl group of a preformed hydrophobic polymer can be post functionalised with a compound such as thiobutyrolactone.

Hydrophilic CTAs typically contain hydrogen bonding and/or permanent or transient charges. Hydrophilic CTAs include but are not limited to: thio-acids such as thioglycolic acid and cysteine, thioamines such as cysteamine and thio-alcohols such as 2-mercaptoethanol, thioglycerol and ethylene glycol mono- (and di-)thio glycollate. Hydrophilic macro-CTAs (where the molecular weight of the CTA is at least 1000 Daltons) can be prepared from hydrophilic polymers synthesised by RAFT (or MADIX) followed by reduction of the chain end, or alternatively the terminal hydroxyl group of a preformed hydrophilic polymer can be post functionalised with a compound such as thiobutyrolactone.

Amphiphilic CTAs can also be incorporated in the polymerisation mixture, these materials are typically hydrophobic alkyl-containing thiols possessing a hydrophilic function such as but not limited to a carboxylic acid group. Molecules of this type include mercapto undecylenic acid.

Responsive macro-CTAs (where the molecular weight of the CTA is at least 1000 Daltons) can be prepared from responsive polymers synthesised by RAFT (or MADIX) followed by reduction of the chain end, or alternatively the terminal hydroxyl group of a preformed responsive polymer, such as poly(propylene glycol), can be post functionalised with a compound such as thiobutyrolactone. Non-thiol based chain transfer agents (CTAs) such as 2,4-diphenyl-4-methyl-1-pentene can also be used.

The residue of the chain transfer agent may comprise 0 to 80 mole % of the copolymer (based on the number of moles of monofunctional monomer). More preferably the residue of the chain transfer agent comprises 0 to 50 mole %, even more preferably 0 to 40 mole % of the copolymer (based on the number of moles of monofunctional monomer). However, most especially the chain transfer agent comprises 0.05 to 30 mole %, of the copolymer (based on the number of moles of monofunctional monomer).

The initiator is a free-radical initiator and can be any molecule known to initiate free-radical polymerisation such as for example azo-containing molecules, persulfates, redox initiators, peroxides, benzyl ketones. These may be activated via thermal, photolytic or chemical means. Examples of these include but are not limited to: 2,2′-azobisisobutyronitrile (AIBN), azobis(4-cyanovaleric acid), benzoyl peroxide, tert-butyl peroxybenzoate (Luperox® P), di-tert-butyl peroxide (Luperox® DI), diisopropyl peroxide, cumylperoxide, 1-hydroxycyclohexyl phenyl ketone, hydrogenperoxide/ascorbic acid. Iniferters such as benzyl-N,N-diethyldithiocarbamate can also be used. In some cases, more than one initiator may be used. The initiator may be a macroinitiator having a molecular weight of at least 1000 Daltons. In this case, the macroinitiator may be hydrophilic, hydrophobic, or responsive in nature.

Preferably, the residue of the initiator in a free-radical polymerisation comprises from 0 to 10% weight/weight of the copolymer based on the total weight of the monomers. More preferably the residue of the initiator in a free-radical polymerisation comprises from 0.001 to 8% weight/weight of the copolymer. Most especially the residue of the initiator in a free-radical polymerisation comprises from 0.001 to 5% weight/weight of the copolymer based on the total weight of the monomers.

The use of a chain transfer agent and an initiator is preferred. However, some molecules can perform both functions.

Hydrophilic macroinitiators (where the molecular weight of the pre-formed polymer is at least 1000 Daltons) can be prepared from hydrophilic polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

Hydrophobic macroinitiators (where the molecular weight of the preformed polymer is at least 1000 Daltons) can be prepared from hydrophobic polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

Responsive macroinitiators (where the molecular weight of the preformed polymer is at least 1000 Daltons) can be prepared from responsive polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

The monofunctional monomer may comprise any carbon-carbon unsaturated compound which can be polymerised by an addition polymerisation mechanism, for example vinyl and allyl compounds. The monofunctional monomer may be hydrophilic, hydrophobic, amphiphilic, anionic, cationic, neutral or zwitterionic in nature. The monofunctional monomer may be selected from but not limited to monomers such as: vinyl acids, vinyl acid esters, vinyl aryl compounds, vinyl acid anhydrides, vinyl amides, vinyl ethers, vinyl amines, vinyl aryl amines, vinyl nitriles, vinyl ketones, and derivatives of the aforementioned compounds as well as corresponding allyl variants thereof.

Other suitable monofunctional monomers include: hydroxyl-containing monomers and monomers which can be post-reacted to form hydroxyl groups, acid-containing or acid-functional monomers, zwitterionic monomers and quaternised amino monomers. Oligomeric, polymeric and di- or multi-functionalised monomers may also be used, especially oligomeric or polymeric(meth)acrylic acid esters such as mono(alk/aryl) (meth)acrylic acid esters of polyalkyleneglycol or polydimethylsiloxane or any other mono-vinyl or allyl adduct of a low molecular weight oligomer. Mixtures of more than one monomer may also be used to give statistical, graft, gradient or alternating copolymers.

Vinyl acids and derivatives thereof include: (meth)acrylic acid, fumaric acid, maleic acid, itaconic acid and acid halides thereof such as (meth)acryloyl chloride. Vinyl acid esters and derivatives thereof include: C1 to C20 alkyl(meth)acrylates (linear & branched) such as for example methyl(meth)acrylate, stearyl(meth)acrylate and 2-ethyl hexyl(meth)acrylate; aryl(meth)acrylates such as for example benzyl(meth)acrylate; tri(alkyloxy)silylalkyl(meth)acrylates such as trimethoxysilylpropyl(meth)acrylate; and activated esters of (meth)acrylic acid such as N-hydroxysuccinamido(meth)acrylate. Vinyl aryl compounds and derivatives thereof include: styrene, acetoxystyrene, styrene sulfonic acid, 2- and 4-vinyl pyridine, vinyl naphthalene, vinylbenzyl chloride and vinyl benzoic acid. Vinyl acid anhydrides and derivatives thereof include: maleic anhydride. Vinyl amides and derivatives thereof include: (meth)acrylamide, N-(2-hydroxypropyl)methacrylamide, N-vinyl pyrrolidone, N-vinyl formamide, (meth)acrylamidopropyl trimethyl ammonium chloride, [3-((meth)acrylamido)propyl]dimethyl ammonium chloride, 3- [N-(3-(meth)acrylamidopropyl)-N,N-dimethyl]aminopropane sulfonate, methyl(meth)acrylamidoglycolate methyl ether and N-isopropyl(meth)acrylamide. Vinyl ethers and derivatives thereof include: methyl vinyl ether. Vinyl amines and derivatives thereof include: dimethylaminoethyl(meth)acrylate, diethylaminoethyl (meth)acrylate, diisopropylaminoethyl (meth)acrylate, mono-t-butylaminoethyl(meth)acrylate, morpholinoethyl(meth)acrylate and monomers which can be post-reacted to form amine groups, such as N-vinyl formamide. Vinyl aryl amines and derivatives thereof include: vinyl aniline, 2 and 4-vinyl pyridine, N-vinyl carbazole and vinyl imidazole. Vinyl nitriles and derivatives thereof include: (meth)acrylonitrile. Vinyl ketones or aldehydes and derivatives thereof including acrolein.

Hydroxyl-containing monomers include: vinyl hydroxyl monomers such as hydroxyethyl(meth)acrylate, 1- and 2-hydroxy propyl(meth)acrylate, glycerol mono(meth)acrylate and sugar mono(meth)acrylates such as glucose mono(meth)acrylate. Monomers which can be post-reacted to form hydroxyl groups include: vinyl acetate, acetoxystyrene and glycidyl(meth)acrylate. Acid—containing or acid functional monomers include: (meth)acrylic acid, styrene sulfonic acid, vinyl phosphonic acid, vinyl benzoic acid, maleic acid, fumaric acid, itaconic acid, 2-(meth)acrylamido 2-ethyl propanesulfonic acid, mono-2-((meth)acryloyloxy)ethyl succinate and ammonium sulfatoethyl(meth)acrylate. Zwitterionic monomers include: (meth)acryloyl oxyethylphosphoryl choline and betaines, such as [2-((meth)acryloyloxy)ethyl]dimethyl-(3-sulfopropyl)ammonium hydroxide. Quaternised amino monomers include: (meth)acryloyloxyethyltri-(alk/aryl)ammonium halides such as (meth)acryloyloxyethyltrimethyl ammonium chloride.

Vinyl acetate and derivatives thereof can also be utilised.

Oligomeric and polymeric monomers include: oligomeric and polymeric (meth)acrylic acid esters such as mono(alk/arypoxypolyalkyleneglycohmeth)acrylates and mono(alk/aryl)oxypolydimethyl-siloxane(meth)acrylates. These esters include for example: monomethoxy oligo(ethyleneglycol)mono(meth)acrylate, monomethoxy oligo(propyleneglycol) mono(meth)acrylate, monohydroxy oligo(ethyleneglycol)mono(meth)acrylate, monohydroxy oligo(propyleneglycol)mono(meth)acrylate, monomethoxy poly(ethyleneglycol)mono(meth)acrylate, monomethoxy poly(propyleneglycol)mono(meth)acrylate, monohydroxy poly(ethyleneglycol)mono(meth)acrylate and monohydroxy poly(propyleneglycol)mono(meth)acrylate. Further examples include: vinyl or allyl esters, amides or ethers of pre-formed oligomers or polymers formed via ring-opening polymerisation such as oligo(caprolactam), oligo(caprolactone), poly(caprolactam) or poly(caprolactone), or oligomers or polymers formed via a living polymerisation technique such as poly(l,4-butadiene).

The corresponding allyl monomers to those listed above can also be used where appropriate.

Examples of monofunctional monomers are: Amide-containing monomers such as (meth)acrylamide, N-(2-hydroxypropyl)methacrylamide, N,N′-dimethyl(meth)acrylamide, N and/or N′-di(alkyl or aryl) (meth)acrylamide, N-vinyl pyrrolidone, [3-((meth)acrylamido)propyl]trimethyl ammonium chloride, 3-(dimethylamino)propyl(meth)acrylamide, 3 - [N-(3 -(meth)acrylamidopropyl)-N,N-dimethyl]aminopropane sulfonate, methyl (meth)acrylamidoglycolate methyl ether and N-isopropyl(meth)acrylamide; (Meth)acrylic acid and derivatives thereof such as (meth)acrylic acid, (meth)acryloyl chloride (or any halide), (alkyl/aryl)(meth)acrylate; functionalised oligomeric or polymeric monomers such as monomethoxy oligo(ethyleneglycol) mono(meth)acrylate, monomethoxy oligo(propyleneglycol) mono(meth)acrylate, monohydroxy oligo(ethyleneglycol) mono(meth)acrylate, monohydroxy oligo(propyleneglycol) mono(meth)acrylate, monomethoxy poly(ethyleneglycol)mono(meth)acrylate, monomethoxy poly(propyleneglycol) mono(meth)acrylate, monohydroxy poly(ethyleneglycol) mono(meth)acrylate, monohydroxy poly(propyleneglycol) mono(meth)acrylate, glycerol mono(meth)acrylate and sugar mono(meth)acrylates such as glucose mono(meth)acrylate; vinyl amines such as aminoethyl(meth)acrylate, dimethylaminoethyl(meth)acrylate, diethylaminoethyl(meth)acrylate, diisopropyl amino ethyl(meth)acrylate, mono-t-butylamino(meth)acrylate, morpholinoethyl(meth)acrylate; vinyl aryl amines such as vinyl aniline, vinyl pyridine, N-vinyl carbazole, vinyl imidazole, and monomers which can be post-reacted to form amine groups, such as vinyl formamide; vinyl aryl monomers such as styrene, vinyl benzyl chloride, vinyl toluene, a-methyl styrene, styrene sulfonic acid, vinyl naphthalene and vinyl benzoic acid; vinyl hydroxyl monomers such as hydroxyethyl(meth)acrylate, hydroxy propyl(meth)acrylate, glycerol mono(meth)acrylate or monomers which can be post-functionalised into hydroxyl groups such as vinyl acetate, acetoxy styrene and glycidyl(meth)acrylate; acid-containing monomers such as (meth)acrylic acid, styrene sulfonic acid, vinyl phosphonic acid, vinyl benzoic acid, maleic acid, fumaric acid, itaconic acid, 2-(meth)acrylamido 2-ethyl propanesulfonic acid, 2-acrylamido 2-methylpropane sulfonic acid and mono-2-((meth)acryloyloxy)ethyl succinate or acid anhydrides such as maleic anhydride; zwitterionic monomers such as (meth)acryloyl oxyethylphosphoryl choline and betaine-containing monomers, such as [2-((meth)acryloyloxy)ethyl]dimethyl-(3-sulfopropyl)ammonium hydroxide; quaternised amino monomers such as (meth)acryloyloxyethyltrimethyl ammonium chloride, vinyl acetate or vinyl butanoate or derivatives thereof.

The corresponding allyl monomer, where applicable, can also be used in each case.

Functional monomers, that is monomers with reactive pendant groups which can be pre or post-modified with another moiety following polymerisation can also be used such as for example glycidyl(meth)acrylate, tri(alkoxy)silylalkyl(meth)acrylates such as trimethoxysilylpropyl(meth)acrylate, (meth)acryloyl chloride, maleic anhydride, hydroxyalkyl(meth)acrylates, (meth)acrylic acid, vinylbenzyl chloride, activated esters of (meth)acrylic acid such as N-hydroxysuccinamido(meth)acrylate and acetoxystyrene.

Macromonomers (monomers having a molecular weight of at least 1000 Daltons) are generally formed by linking a polymerisable moiety, such as a vinyl or allyl group, to a pre-formed monofunctional polymer via a suitable linking unit such as an ester, an amide or an ether. Examples of suitable polymers include: mono functional poly(alkylene oxides) such as monomethoxy[poly(ethyleneglycol)] or monomethoxy[poly(propyleneglycol)], silicones such as poly(dimethylsiloxane)s, polymers formed by ring-opening polymerisation such as poly(caprolactone) or poly(caprolactam) or mono-functional polymers formed via living polymerisation such as poly(l,4-butadiene).

Preferred macromonomers include: monomethoxy[poly(ethyleneglycol)]mono(methacrylate), monomethoxy[poly(propyleneglycol)]mono(methacrylate) and mono(meth)acryloxypropyl-terminated poly(dimethylsiloxane).

When the monofunctional monomer is providing the necessary hydrophilicity in the copolymer, it is preferred that the monofunctional monomer is a residue of a hydrophilic monofunctional monomer, preferably having a molecular weight of at least 1000 Daltons.

Hydrophilic monofunctional monomers include: (meth)acryloyl chloride, N-hydroxysuccinamido(meth)acrylate, styrene sulfonic acid, maleic anhydride, (meth)acrylamide, N-(2-hydroxypropyl)methacrylamide, N-vinyl pyrrolidinone, N-vinyl formamide, quaternised amino monomers such as (meth)acrylamidopropyl trimethyl ammonium chloride, [3-((meth)acrylamido)propyl]trimethyl ammonium chloride and (meth)acryloyloxyethyltrimethyl ammonium chloride, 3-[N-(3-(meth)acrylamidopropyl)-N,N-dimethyl]aminopropane sulfonate, methyl(meth)acrylamidoglycolate methyl ether, glycerol mono(meth)acrylate, monomethoxy and monohydroxy oligo(ethylene oxide) (meth)acrylate, sugar mono(meth)acrylates such as glucose mono(meth)acrylate, (meth)acrylic acid, vinyl phosphonic acid, fumaric acid, itaconic acid, 2-(meth)acrylamido 2-ethyl propanesulfonic acid, mono-2-((meth)acryloyloxy)ethyl succinate, ammonium sulfatoethyl(meth)acrylate, (meth)acryloyl oxyethylphosphoryl choline and betaine-containing monomers such as [2-((meth)acryloyloxy)ethyl]dimethyl-(3-sulfopropyl)ammonium hydroxide. Hydrophilic macromonomers may also be used and include: monomethoxy and monohydroxy poly(ethylene oxide) (meth)acrylate and other hydrophilic polymers with terminal functional groups which can be post-functionalised with a polymerisable moiety such as (meth)acrylate, (meth)acrylamide or styrenic groups.

Hydrophobic monofunctional monomers include: C1 to C28 alkyl(meth)acrylates (linear and branched) and (meth)acrylamides, such as methyl(meth)acrylate and stearyl(meth)acrylate, aryl(meth)acrylates such as benzyl(meth)acrylate, tri(alkyloxy)silylalkyl(meth)acrylates such as trimethoxysilylpropyl(meth)acrylate, styrene, acetoxystyrene, vinylbenzyl chloride, methyl vinyl ether, vinyl formamide, (meth)acrylonitrile, acrolein, 1- and 2-hydroxy propyl(meth)acrylate, vinyl acetate, 5-vinyl 2-norbornene, Isobornyl methacrylate and glycidyl(meth)acrylate. Hydrophobic macromonomers may also be used and include: monomethoxy and monohydroxy poly(butylene oxide) (meth)acrylate and other hydrophobic polymers with terminal functional groups which can be post-functionalised with a polymerisable moiety such as (meth)acrylate, (meth)acrylamide or styrenic groups.

Responsive monofunctional monomers include: (meth)acrylic acid, 2- and 4-vinyl pyridine, vinyl benzoic acid, N-isopropyl(meth)acrylamide, tertiary amine(meth)acrylates and (meth)acrylamides such as 2-(dimethyl)aminoethyl(meth)acrylate, 2-(diethylamino)ethyl(meth)acrylate, diisopropylaminoethyl(meth)acrylate, mono-t-butylaminoethyl(meth)acrylate and N-morpholinoethyl(meth)acrylate, vinyl aniline, 2- and 4-vinyl pyridine, N-vinyl carbazole, vinyl imidazole, hydroxyethyl (meth)acrylate, hydroxypropyl(meth)acrylate, maleic acid, fumaric acid, itaconic acid and vinyl benzoic acid. Responsive macromonomers may also be used and include: monomethoxy and monohydroxy poly(propylene oxide) (meth)acrylate and other responsive polymers with terminal functional groups which can be post-functionalised with a polymerisable moiety such as (meth)acrylate, (meth)acrylamide or styrenic groups.

Monomers based on styrene or those containing an aromatic functionality such as styrene, a-methyl styrene, vinyl benzyl chloride, vinyl naphthalene, vinyl benzoic acid, N-vinyl carbazole, 2-, 3- or 4- vinyl pyridine, vinyl aniline, acetoxy styrene, styrene sulfonic acid, vinyl imidazole or derivatives thereof.

Preferred monomers are selected from the group consisting of: styrene, vinyl benzyl chloride, 2-vinyl pyridine, 4-vinyl pyridine, methyl acrylate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, divinyl benzene, ethyleneglycol dimethacrylate, ethyleneglycol diacrylate, triethylene glycol dimethacrylate, tetraethyleneglycol dimethacrylate, triethyleneglycol diacrylate, tetraethyleneglycol diacrylate, glycidyl methacrylate, Tetrahydrofurfuryl methacrylate, (thiirane-2-yl)methyl methacrylate,

The multifunctional monomer or brancher may comprise a molecule containing at least two vinyl groups which may be polymerised via addition polymerisation. The molecule may be hydrophilic, hydrophobic, amphiphilic, neutral, cationic, zwitterionic, oligomeric or polymeric. Such molecules are often known as cross-linking agents in the art and may be prepared by reacting any di- or multifunctional molecule with a suitably reactive monomer. Examples include: di- or multivinyl esters, di- or multivinyl amides, di- or multivinyl aryl compounds, di- or multivinyl alk/aryl ethers. Typically, in the case of oligomeric or polymeric di- or multifunctional branching agents, a linking reaction is used to attach a polymerisable moiety to a di- or multifunctional oligomer or polymer. The brancher may itself have more than one branching point, such as T-shaped divinylic oligomers or polymers. In some cases, more than one multifunctional monomer may be used. When the multifunctional monomer is providing the necessary hydrophilicity in the copolymer, it is preferred that the multifunctional monomer has a molecular weight of at least 1000 Daltons.

The corresponding allyl monomers to those listed above can also be used where appropriate.

Preferred multifunctional monomers or branchers include but are not limited to divinyl aryl monomers such as divinyl benzene; (meth)acrylate diesters such as ethylene glycol di(meth)acrylate, propyleneglycol di(meth)acrylate and 1,3-butylenedi(meth)acrylate; polyalkylene oxide di(meth)acrylates such as tetraethyleneglycol di(meth)acrylate, poly(ethyleneglycol) di(meth)acrylate and poly(propyleneglycol) di(meth)acrylate; divinyl(meth)acrylamides such as methylene bisacrylamide; silicone-containing divinyl esters or amides such as (meth)acryloxypropyl-terminated poly(dimethylsiloxane); divinyl ethers such as poly(ethyleneglycol)divinyl ether; and tetra- or tri-(meth)acrylate esters such as pentaerythritol tetra(meth)acrylate, trimethylolpropane tri(meth)acrylate or glucose di- to penta(meth)acrylate. Further examples include vinyl or allyl esters, amides or ethers of pre-formed oligomers or polymers formed via ring-opening polymerisation such as oligo(caprolactam), oligo(caprolactone), 1,3,5 -triallyl-1,3, 5-triazine-2,4, 6 (1H;3H;5H)-trione, poly(caprolactam) or poly(caprolactone), or oligomers or polymers formed via a living polymerisation technique such as oligo- or poly(1,4-butadiene).

Macro-crosslinkers or macrobranchers (multifunctional monomers having a molecular weight of at least 1000 Daltons) are generally formed by linking a polymerisable moiety, such as a vinyl or aryl group, to a pre-formed multifunctional polymer via a suitable linking unit such as an ester, an amide or an ether. Examples of suitable polymers include: di-functional poly(alkylene oxides) such as poly(ethyleneglycol) or poly(propyleneglycol), silicones such as poly(dimethylsiloxane)s, polymers formed by ring-opening polymerisation such as poly(caprolactone) or poly(caprolactam) or poly-functional polymers formed via living polymerisation such as poly(l,4-butadiene).

Preferred macrobranchers include: poly(ethyleneglycol) di(meth)acrylate, poly(propyleneglycol) di(meth)acrylate, methacryloxypropyl-terminated poly(dimethylsiloxane), poly(caprolactone) di(meth)acrylate and poly(caprolactam) di(meth)acrylamide.

Branchers include: methylene bisacrylamide, glycerol di(meth)acrylate, glucose di- and tri(meth)acrylate, oligo(caprolactam) and oligo(caprolactone). Multi end-functionalised hydrophilic polymers may also be functionalised using a suitable polymerisable moiety such as a (meth)acrylate, (meth)acrylamide or styrenic group.

Further branchers include: divinyl benzene, (meth)acrylate esters such as ethyleneglycol di(meth)acrylate, propyleneglycol di(meth)acrylate and 1,3-butylene di(meth)acrylate, oligo(ethylene glycol) di(meth)acrylates such as tetraethylene glycol di(meth)acrylate, tetra- or tri-(meth)acrylate esters such as pentaerythritol tetra(meth)acrylate, trimethylolpropane tri(meth)acrylate and glucose penta(meth)acrylate. Multi end-functionalised hydrophobic polymers may also be functionalised using a suitable polymerisable moiety such as a (meth)acrylate, (meth)acrylamide or styrenic group.

Multifunctional responsive polymers may also be functionalised using a suitable polymerisable moiety such as a (meth)acrylate, (meth)acrylamide or styrenic group such as poly(propylene oxide) di(meth)acrylate.

Styrenic branchers, or those containing aromatic functionality are particularly preferred including divinyl benzene, divinyl naphthalene, acrylate or methacrylate derivatives of 1,4 or 1,3 or 1,2 derivatives of dihydroxy dimethyl benzene and derivatives thereof.

### EXAMPLES

The present invention will now be explained in more detail by reference to the following non-limiting examples.

In the following examples, copolymers are described using the following nomenclature:

(MonomerG)_{g} (Monomer J)ⱼ (Brancher L)ₗ (Chain Transfer Agent)_{d}

wherein the values in subscript are the molar ratios of each constituent normalised to give the monofunctional monomer values as 100, that is, g+j=100. The degree of branching or branching level is denoted by 1 and d refers to the molar ratio of the chain transfer agent.

For example: Methacrylic acid100 Ethyleneglycol dimethacrylate15 Dodecane thiol15 would describe a polymer containing methacrylic acid : ethyleneglycol dimethacrylate : dodecane thiol at a molar ratio of 100:15:15.

### Abbreviations:

### Monomers

AMA Allyl methacrylate

BMA n-Butyl Methacrylate

GMA Glycidyl methacrylate

HEMA Hydroxyethyl methacrylate

HPMA 2-Hydroxypropyl methacrylate

MMA Methyl methacrylate

### Branchers

DVB Divinyl benzenes (80% grade)

EGDMA Ethyleneglycol dimethacrylate

### Chain Transfer Agents (CTAs)

DDT 1-Dodecane thiol

2ME 2-Mercaptoethanol

### Initiators

ABCC 1,1 -Azobis(cyclohexane- 1-carbonitrile)

DI Luperox® DI (Di-t-butyl peroxide)

P Luperox® P (t-butyl peroxybenzoate)

### Solvents/Miscellaneous

MEK Butan-2-one

THF Tetrahydrofuran

MDA Bis-(4-aminophenyl)methane

IETA Triethylene tetramine

All materials were obtained from the Aldrich Chemical Company with the exception of Luperox® DI and P, which were obtained from Arkema Chemical Company, and Desmodur® N3390 from Bayer.

### Synthesis and Characterisation

General procedure. Into a three-necked round bottom flask fitted in a DrySyn® Vortex Overhead Stirrer system and equipped with a condenser the monomers and the solvent were introduced. The solution was degassed for ten minutes by sparging with nitrogen. The solution was then heated to the appropriate temperature and stirred at 320 rpm. When the expected temperature was reached, the initiator was added and the reaction was allowed to start and continued for between 5 and 20 hours, until the conversion was found to be greater than 99% (measured by ¹H NMR). The reaction mixture was cooled to room temperature and poured into a jar. The polymers were characterised by TD-SEC.

Triple Detection-Size Exclusion Chromatography. The instrument package was supplied by Viscotek and consists of a GPCmax eluent pump and autosampler, which is coupled to a TDA302 column oven and a multidetector module. The columns used were two ViscoGel HHR-H columns and a guard column with an exclusion limit for polystyrene of 10⁷ g.mol⁻¹.

Tetrahydrofuran (THF) was the mobile phase, the column oven temperature was set to 35° C., and the flow rate was 1 mL.min⁻¹. The samples were prepared for injection by dissolving 10 mg of polymer in 1.5 mL of HPLC grade THF and filtered through an Acrodisc® 0.2 μm PTFE membrane. 0.1 mL of this mixture was then injected, and data points were collected for 30 minutes. Omnisec was used to collect and process the signals transmitted from the detectors to the computer and to calculate the molecular weight.

### SPECIFIC EXAMPLES

### Example 1

### (BP1)—AMA polymer Synthesis

### MMA₅₀ BMA₅ AMA₄₅ EGDMA₅ DDT₁₉

Methyl methacrylate (MMA) (15 g, 0.15 mol), n-butyl methacrylate (BMA) (2.13 g, 15 mmol), allyl methacrylate (AMA) (17 g, 0.135 mol), ethylene glycol dimethacrylate (EGDMA) (2.97 g, 15 mmol), dodecanethiol (DDT) (11.52 g, 57 mmol), 1,1-azobis(cyclohexane-1-carbonitrile) (ABCC) (1.61 g, 6.6 mmol) and toluene (48.6 g) were added to a 250 mL 3 neck round bottomed flask fitted with an overhead stirrer and equipped with a condenser. The solution was degassed for 30 minutes by purging with nitrogen. The solution was then heated to 100° C. and stirred for 19 hours. The reaction mixture was then cooled to room temperature and the polymer was precipitated into 1 litre of cold hexanes. The precipitated polymer was isolated by filtration and dried under vacuum at 40° C. until constant mass. The branched polymer was characterised as follow: Mn 20, 000 g/mol, Mw 336, 000 g/mol, Mw/Mn 17, a 0.324, viscosity 579 mPa.s at 25° C. (50% solid in butyl acetate).

### Example 2

### (BP2)—Polyol Synthesis

### MMA₄₁BA₂₀HEMA₃₉DVB₂₅2ME₃₅

Methyl methacrylate (MMA) (15 g, 0.15 mol), BA (9.37 g, 73.1 mmol), hydroxyethyl methacrylate (HEMA) (18.55 g, 0.142 mol), divinyl benzene (DVB) (80% grade, 11.89 g, 91.3 mmol), 2-mercaptoethanol (2ME) (9.92 g, 0.127 mol) and butyl acetate (27.8 g) were added to a 250 mL 3 neck round bottomed flask fitted with an overhead stirrer system and equipped with a condenser. The solution was degassed for 30 minutes by purging with nitrogen. The solution was then heated to 126° C. with stiffing. When the reaction mixture started to reflux, Luperox® DI (1.04 mL, 5.4 mmol) was added. Additional aliquots of Luperox® DI (1.04 mL, 5.4 mmol per addition) were injected after 30, 60, 90 and 180 minutes of reaction. After 5 hours, the reaction mixture was cooled to room temperature. The branched polymer was characterised as follow: Mn 1300 g/mol, Mw 28000 g/mol, Mw/Mn 21, a 0.471, viscosity 143 mPa.s at 25° C. (50% solid in butyl acetate).

### Example 3

### Coating and Curing Procedure for AMA-Based Branched Polymers

Branched polymer example 1 (BP1) was dissolved in butyl acetate to give a 50% w/w solution. Cobalt naphthenate solution—solvent (2% of Co versus AMA weight/weight), N,N-dimethylaniline (0.25% versus AMA mol/mol), benzoyl peroxide (1.2% versus AMA mol/mol) and Luperox® P (2.3% versus AMA mol/mol) were then added and the solution was thoroughly mixed. The sample was then drawn down on an aluminium panel coatings panel using a 50 μm spiral applicator. The sample was allowed to dry for 5 minutes at ambient temperature before being baked at 80° C. for 15 minutes. The sample was then left to cool to room temperature before adding to a bath of dichloromethane The cured polymer did not dissolve in the solvent indicating that it was cross-linked.

### Example 4

### Coating and Curing Procedure for Branched Polyol Materials

A clearcoat two-pack standard coating was prepared using the previously prepared polyol, a diisocyanate and a tin catalyst in butyl acetate. Branched polyol BP2 was dissolved in butyl acetate (Pack A) and mixed thoroughly with the diisocyanate Desmodur® N3390 (Pack B) in conjunction with a dibutyltin dilaurate catalyst. The resultant RFU (ready for use) clearcoat prepared had the following characteristics: Activated RFU solids=50% weight/weight, NCO:OH molar ratio=1.2 and the level of dibutyltin dilaurate catalyst solution (as 1% by weight in butyl acetate)=1.0% by weight on dry formulation. The sample was drawn down over an aluminium panel using a 100 μm spiral applicator. The sample was allowed to dry for 3 hours at ambient temperature before being baked at 60° C. for 30 minutes. The sample was then left to cure further overnight before being tested for pendulum hardness (BS EN ISO 1522).

Table 1 provides the synthetic procedures for the synthesis of linear and branched polymers.

TABLE 1

| | | | Reaction | | |
|---|---|---|---|---|---|
| Example | Solid | | Temperature | | Amount of |
| Number | content^{a} | Solvent | (° C.) | Initiator | initiator^{b} |
| LP1 | 30.0 | BuOAc | 126 | P | 2.25 |
| LP2 | 30.0 | BuOAc | 126 | P | 2.25 |
| LP3 | 30.0 | BuOAc | 126 | P | 2.25 |
| LP4 | 30.0 | Xylene | 145 | DI | 2.00 |
| LP5 | 30.0 | Xylene | 145 | DI | 2.00 |
| LP6 | 30.0 | Xylene | 145 | DI | 2.00 |
| BP3 | 20.0 | BuOAc | 126 | P | 1.50 |
| BP4 | 35.5 | BuOAc | 126 | P | 2.41 |
| BP5 | 20.0 | BuOAc | 126 | P | 1.98 |
| BP6 | 30.0 | BuOAc | 126 | P | 1.88 |
| BP7 | 35.0 | BuOAc | 126 | P | 1.88 |
| BP8 | 35.0 | BuOAc | 126 | P | 1.88 |
| BP9 | 30.0 | Xylene | 145 | DI | 2.00 |
| BP10 | 30.0 | Xylene | 145 | DI | 2.00 |
| BP11 | 30.0 | Xylene | 145 | DI | 2.00 |

In Table 1:
^{a}is the solid content as weight percent (wt. %); and
^{b}is the molar percentage (Mol. %) relative to the number of double bonds.

Table 2 Provides the compositional and analytical data for the prepared linear and branched polymers

TABLE 2

| Example | | | | | |
|---|---|---|---|---|---|
| Number | Composition^{d} | Mn^{e} | Mw^{e} | Mw/Mn | α |
| LP1 | MMA_{59.34}BMA_{29.02}HPMA_{11.64} | 2.9 | 34.5 | 12.0 | 0.76 |
| LP2 | MMA₄₀BMA_{19.4}HPMA_{40.6} | 3.6 | 46.0 | 13.0 | 0.78 |
| LP3 | MMA₅₀BMA_{23.1}HPMA_{26.9} | 3.4 | 43.0 | 13.0 | 0.80 |
| LP4 | MMA₆₅GMA₃₅DDT₂ | 0.5 | 10.2 | 20.0 | 0.60 |
| LP5 | MMA₅₇GMA₄₃DDT₂ | 0.5 | 10.8 | 22.0 | 0.59 |
| LP6 | MMA₅₀GMA₅₀DDT₂ | 0.6 | 11.4 | 19.0 | 0.64 |
| BP3 | MMA₅₉BMA₃₀HPMA₁₁EGDMA_{0.53}2ME_{0.8} | 3.0 | 32.0 | 11.0 | 0.69 |
| BP4 | MMA₅₉BMA₃₀HPMA₁₁EGDMA_{0.53}2ME_{0.8} | 4.5 | 59.0 | 13.0 | 0.64 |
| BP5 | MMA₄₀BMA₂₀HPMA₄₀EGDMA_{1.3}2ME₂ | 4.3 | 21.5 | 5.0 | 0.51 |
| BP6 | MMA₄₀BMA₂₀HPMA₄₀EGDMA_{1.3}2ME₂ | 4.8 | 36.0 | 7.5 | 0.54 |
| BP7 | MMA₄₀BMA₂₀HPMA₄₀EGDMA_{1.3}2ME₂ | 6.6 | 77.0 | 12.0 | 0.50 |
| BP8 | MMA₄₉BMA_{24.5}HPMA_{26.5}EGDMA_{1.2}2ME_{1.9} | 8.1 | 67.0 | 8.3 | 0.52 |
| BP9 | MMA₅₀GMA₅₀EGDMA₁₀DDT₁₃ | 1.0 | 11.4 | 11.0 | 0.55 |
| BP10 | MMA₄₀GMA₆₀EGDMA₁₀DDT₁₃ | 0.9 | 10.1 | 11.0 | 0.57 |
| BP11 | MMA₃₀GMA₇₀EGDMA₁₀DDT₁₃ | 1.0 | 9.8 | 9.8 | 0.45 |

In Table 2:
^{d}is the molar ratio; and
^{e}is kg/mole.
Mn represents the number average molecular weight in kDa
Mw represents the weight average molecular weight in kDa
Mw/Mn represents the polydispersity of the polymers
α - represents the Mark-Houwink alpha value.

### Viscosity Measurements

The polymers were dissolved in the appropriate solvent and made up to the stated percentage weight/weight solutions and the viscosities of the polymers measured on a Brookfield DV-II+Pro Viscometer, fitted with a CP-40 or CP-52 at 25° C. Branched and linear polyol were dissolved in MEK, branched and linear epoxide in xylene and AMA-based branched polymer in butyl acetate.

### Coating and Curing Procedure for Branched and Linear Polyol Materials

Clearcoat two-pack standard coatings were prepared using the previously prepared polyols, a diisocyanate and a tin catalyst in butyl acetate. The polyols were dissolved in butyl acetate (Pack A) and mixed thoroughly with the diisocyanate Desmodur® N3390 (Pack B) in conjunction with a dibutyltin dilaurate catalyst. The resultant RFU (ready for use) clearcoats prepared had the following characteristics: Activated RFU solids=50% weight/weight in MEK, NCO:OH molar ratio=1.2 and the level of dibutyltin dilaurate catalyst solution (as 1% by weight in butyl acetate)=1.0% by weight on dry formulation.

### Pendulum Hardness

Pendulum hardness to BS EN ISO 1522 using the Koenig pendulum.

The samples were drawn down over a glass panel using a 100 μm key bar applicator. The samples were allowed to dry for 30 minutes at ambient temperature before being baked at 60° C. for 2 hours. After 2 days at room temperature, the hardness measurements were performed.

### Scratch Resistance

A scratch resistance test in accordance with BS EN ISO 1518 was carried out. The samples were drawn over an aluminium panel using a 100 μm spiral applicator. The samples were allowed to dry for 30 minutes at ambient temperature before being baked at 60° C. for 2 hours. After 2 days at room temperature, the scratch resistance measurements were performed.

### Drying Time (BK Recorder)

Wet draw downs (75 microns) of the clearcoats were made over half inch thick glass strips which were then placed on a BK drying time recorder. The drying times of the clearcoats were measured using the 12 hour track function of a BK recorder.

### Cross Cut Adhesion

The clearcoats were applied to chromate-treated aluminium panels using a 100 μm spiral coater. The samples were allowed to dry for 30 minutes at ambient temperature before being baked at 60° C. for 2 hours. After 2 days at room temperature, the cross cut adhesion tests were performed in accordance with BS EN ISO 2409 and the percentage failure was recorded.

In Table 3, there is provided the viscosity, drying time and coating characteristics of the polyol branched and linear materials.

TABLE 3

| | | | Drying | 2 pack | | Scratch |
|---|---|---|---|---|---|---|
| Example | | Viscosity^{f} | time^{g} | concentration | Hardness | Resistance |
| Number | OH (mol/g) | (mPa · s) | (minutes) | (%)^{h} | (s) | (g) |
| LP1 | 0.991 | 344 | 285 | 40 | 197 | 1700 |
| LP2 | 3.218 | 374 | 570 | 40 | 204 | 1700 |
| LP3 | 2.211 | 462 | 600 | 40 | 193 | 1600 |
| BP3 | 0.991 | 273 | 180 | 50 | 191 | 900 |
| BP4 | 0.991 | 297 | 60 | 50 | 189 | 1200 |
| BP5 | 3.222 | 135 | 120 | 50 | 198 | 600 |
| BP6 | 3.222 | 164 | 60 | 50 | 207 | 500 |
| BP7 | 3.222 | 255 | 30 | 50 | 206 | 500 |
| BP8 | 2.25 | 200 | 135 | 50 | 209 | 2000 |

In Table 3, f and g - were determined as 50 weight percent solutions in MEK; and h refers to the weight percent solids of the solution in BuOAc.

The data shows that the branched polymer formulations (BP3 to BP8) had a faster curing rate than the compositions prepared from linear materials (LP1 to LP3) with eqiuivalent hardness. Additionally the formulation prepared with BP8 has a greater scratch resistance.

### Coating and Curing Procedure for Branched and Linear Epoxy Materials

The branched and linear epoxy containing materials were dissolved at 50% solid in butyl acetate. A premade solution of amine was added (TETA or MDA at 0.1 g/mL) such as the ratio epoxy/amine=1. The 2 pack solution was rolled on a sample roller until a homogeneous solution was obtained. The solutions were applied to chromate-treated aluminium panels using a 100 μm spiral coater. The samples were allowed to dry for 10 minutes at ambient temperature before being baked at 100° C. for 2 hours. After 48 hours, the pendulum hardness (BS EN ISO 1522), the cross- cut adhesion (BS EN ISO 2409) and the scratch resistance (BS EN ISO 1518) were measured.

In Table 4 there is provided the viscosity, hardness, adhesion and scratch resistance of the GMA containing branched and linear materials.

TABLE 4

| Example | Viscosityⁱ | | | Adhesion |
|---|---|---|---|---|
| Number | (mPa · s) | Amine | Hardness (s) | (% failed) |
| LP4 | 433 | TETA | 178 | 0 |
| LP5 | 583 | TETA | 178 | 50 |
| LP6 | 827 | TETA | 177 | 60 |
| LP6 | 25 | TETA | 105 | 0 |
| BP10 | 42 | TETA | 145 | 2 |
| BP11 | 22 | TETA | 156 | 0 |
| LP4 | 433 | MDA | 205 | 20 |
| LP5 | 583 | MDA | 203 | 0 |
| LP6 | 827 | MDA | 200 | 0 |
| LP6 | 25 | MDA | 118 | 0 |
| BP10 | 42 | MDA | 137 | 0 |
| BP11 | 22 | MDA | 192 | 0 |

In Table 4,
ⁱis 50 weight percent in BuOAc.

Table 4 shows that the epoxide-containing branched polymer-containing formulations had a greater adhesion than their linear counterparts. The formulations also showed lower solution viscosities than the linear materials.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

1. A method of using a branched addition copolymer wherein the branched addition copolymer is cured to form a cross-linked formulation and wherein the branched addition copolymer is obtainable by an addition polymerisation process, and wherein the branched addition polymer comprises a weight average molecular weight of 2,000 Da to 1,500,000 Da.

2. The method of claim 1 wherein the branched addition copolymer comprises:
at least two chains which are covalently linked by a bridge other than at their ends; and wherein
the at least two chains comprise at least one ethylenically monounsaturated monomer, and wherein
the bridge comprises at least one ethylenically polyunsaturated monomer; and wherein
the polymer comprises a residue of a chain transfer agent and optionally a residue of an initiator; and wherein
the mole ratio of polyunsaturated monomer(s) to monounsaturated monomer(s) is in a range of from 1 :100 to 1 :4.

3. The method of claim 1 wherein the branched addition polymer is cured after formation of the branched addition polymer in the addition polymerisation process.

4. The method of claim 1 wherein the branched addition copolymer is cured by the addition of a reactive polymer, oligomer or small molecular weight reactive molecule.

5. The method of claim 1 wherein the branched addition copolymer is cured by means of thermal, photolytic, oxidative, reductive or by the addition of a catalyst or initiator.

6. The method of claim 1 wherein the branched addition copolymer is prepared from monomers comprising one or more of the following groups: hydroxyl, mercapto, amino, carboxylic, epoxy, isocyanate, pyridinyl, vinyl, allyl, (meth)acrylate, styrenyl.

7. The method of claim 6 wherein the branched addition copolymer is cured by means of the reaction of mutually reactive functional groups provided on the monomers.

8. The method of claim 1 wherein the branched copolymer comprises less than 1% impurity.

9. The method of claim 1 wherein the branched addition polymer comprises a weight average molecular weight of 3,000 Da to 900,000 Da.

10. The method of claim 1 wherein at least one of the monounsaturated monomer(s) and polyunsaturated monomer(s) and chain transfer agent(s) is a hydrophilic residue.

11. The method of claim 1 wherein at least one of one of the monounsaturated monomer(s) and polyunsaturated monomer(s) and chain transfer agent(s) is a hydrophobic residue.

12. The method of claim 1 wherein the branched addition copolymer comprises units selected from the groups group consisting of: styrene, vinyl benzyl chloride, 2-vinyl pyridine, 4-vinyl pyridine, methyl acrylate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, divinyl benzene, ethyleneglycol dimethacrylate, ethyleneglycol diacrylate, triethylene glycol dimethacrylate, tetraethyleneglycol dimethacrylate, triethyleneglycol diacrylate, tetraethyleneglycol diacrylate, glycidyl methacrylate, Tetrahydrofurfuryl methacrylate, (thiirane-2-yl)methyl methacrylate, 1,3,5-triallyl-1,3,5-triazine-2,4,6(1 H,3H,5H)-trione, dodecane thiol, hexane thiol, 2-mercaptoethanol and fragments arising from azobis isobutyronitrile, di-f-butyl peroxide and f-butyl peroxybenzoate.

13. The method of claim 1 wherein the branched addition copolymer comprises units selected from the group consisting of: styrene, glycidyl methacrylate, 2-vinyl pyridine, 4-vinyl pyridine, methyl acrylate, methyl methacrylate, butyl methacrylate, butyl acrylate, acrylic acid, methacrylic acid, acrylamide, methacrylamide, dimethyl acrylamide, dimethyl(meth)acrylamide, styrenesulfonic acid, 2-acrylamido 2-methylpropane sulfonic acid, divinyl benzene, ethyleneglycol dimethacrylate, ethyleneglycol diacrylate, triethylene glycol dimethacrylate, dodecane thiol, hexane thiol, 2-mercaptoethanol, azobis isobutyronitrile, di-f-butyl peroxide and f-butyl peroxybenzoate.

14. A cured coating, adhesive or sealant composition prepared using a branched addition copolymer as described in claim 1 wherein the cured composition further comprises a hardener selected from the group consisting of: dibromopentane, dibromo hexane, dibromoheptane, dibromooctane, diiodo pentane, diidohexane, diiodoheptane, diiodooctane, tetramethylhexane 1,6 diaminohexane, tertamethyethylene diamine, tetramethylbutane 1,4 diamine, tolylene diisocyanate and hexamethylene diisocyanate.

15. The method of using a cured branched copolymer according to claim 1 in the application areas selected from the group consisting of: coatings, adhesives, inks, sealants, composites, and resins.

16. A resin comprising a cured branched addition copolymer as described in claim 1.

17. A composite comprising a cured branched addition copolymer as described in claim 1.

18. A coating comprising a cured branched addition copolymer as described in claim 1.

19. An ink comprising a cured branched addition copolymer as described in claim 1.

20. A curing composition containing a branched addition copolymer which shows one or more of the following: faster cure rate; better adhesion; greater scratch resistance than for a formulation containing an equivalent linear polymer.
